(19) United States
(12) Patent Application Publication
(10) Pub. No.: US 2014/0293201 A1
(43) Pub. Date: Oct. 2, 2014

(54) METHOD FOR PRODUCING LAMINATED FILM, POLARIZING PLATE, LIQUID CRYSTAL DISPLAY DEVICE, AND OPTICAL FILM

(71) Applicant: FUJIFILM Corporation, Tokyo (JP)

(72) Inventors: Jun TAKEDA, Kanagawa (JP); Hajime NAKAYAMA, Kanagawa (JP); Yoji ITO, Kanagawa (JP)

(73) Assignee: FUJIFILM Corporation, Tokyo (JP)

(21) Appl. No.: 14/305,442

(22) Filed: Jun. 16, 2014

Related U.S. Application Data
(63) Continuation of application No. PCT/JP2012/083425, filed on Dec. 25, 2012.

(30) Foreign Application Priority Data
Dec. 26, 2011 (JP) 2011-283783

(51) Int. Cl. G02B 5/30; G02F 1/13363

(52) U.S. Cl. CPC G02B 5/305; G02B 5/3083; G02F 1/133634; G02F 2001/133638
USPC 349/118; 359/489.07; 428/212; 428/213; 428/216; 156/247; 156/246

(57) ABSTRACT

A laminated film having a retardation layer A and a layer B that are formed through solvent co-casting is provided. The layer A has a thickness of 5 to 30 μm. The layer B has a higher tensile modulus compared to the layer A. An interlayer peeling force between the layer A and the layer B is 0.05 to 5 N/cm. The laminated film overcomes the deterioration of handling property generally occurring with the reduction of film thickness in solvent casting method.

### CROSS-REFERENCE TO RELATED APPLICATIONS

This application is a Continuation of PCT International Application No. PCT/JP2012/083425 filed Dec. 25, 2012, which claims priority under 35 U.S.C. Section 119(a) to Japanese Patent Application No. 2011-283783 filed Dec. 26, 2011. Each of the above applications is hereby expressly incorporated by reference, in its entirety, into the present application.

### BACKGROUND OF THE INVENTION

1. Field of the Invention

The present invention relates to a laminated film which is used for, e.g., production of various optical films; a polarizing plate and a liquid crystal display device which include the laminated film; and a method for producing an optical film using the laminated film.

2. Background Art

Liquid crystal display device has been widely used as an image display device for a television, a personal computer (PC), etc., owing to its low power consumption and possibility of reduction in thickness. In recent years, the liquid crystal display device, as it has become popular, has been required to be further reduced in thickness, increased in size, and enhanced in performance. Particularly in the use in a notebook computer or a middle to small size computer (smart phone and slate PC), these demands are high and it is required to further reduce the thickness of members (such as a viewing angle compensation film and a polarizing plate protective film) used in the devices.

Solvent casting method is known as a method for forming a film. In solvent casting method, a film is formed through the steps of dissolving a material in an organic solvent to prepare a solution (hereinafter, sometimes referred to as a dope), casting the solution on a support, forming a film while drying the solution on the support, and after the film formation, peeling the film from the support. In the solvent casting method, rupture of the film or the like sometimes occurs during transporting the film on the support or during peeling the film from the support, as the film thickness is reduced. Such deterioration in handling property is one factor inhibiting the reduction of the film thickness.

Melt casting method is another known film forming method. In the melt casting method, a film is formed through the steps of extruding a molten resin into a film form, and cooling the extruded resin. A method in which two or more molten resins are co-extruded has also been proposed (for example, Patent Reference 1). However, the melt casting method involves a problem of larger fluctuation in thickness of the resulting film and more considerable streak irregularity occurring in the film forming direction, compared with the solvent casting method. Furthermore, in the solvent casting, the resin is cooled and solidified immediately after discharged from a T-die, and therefore the method is entirely different from a solvent casting in which a solution is dried while being evaporated, in terms of the interaction between the laminated films, and in addition, the method is characterized in that a change that develops optical properties due to the drying step which is required only in the solvent casting does not occur.

### CITATION LIST

### Patent Reference

Patent Reference 1: JP-B 4517881

### SUMMARY OF INVENTION

The present invention was made in view of the above problems, and an object of the invention is to overcome the deterioration in handling property occurring with the reduction of the film thickness in the solvent casting method.

Specifically, an object of the present invention is to provide a new laminated film which, during the film formation through a solvent casting method, does not cause the problem of deterioration in handling property associated with the reduction of the film thickness, and in use, which can be utilized as a thin retardation film in various applications, and to provide a polarizing plate and a liquid crystal display device which are produced using the laminated film and whose thicknesses can be reduced.

Another object of the present invention is to provide a new method for producing an optical film using the laminated film of the present invention.

The laminated film of the present invention comprises a thin retardation layer A which is formed by a solvent co-casting method, and a layer B which has a higher tensile modulus compared to the retardation layer A, and therefore, good handling property can be maintained during film formation due to the presence of the layer B. In addition, interlayer peeling force between the layer A and the layer B falls within a given range, and therefore, a good adhesiveness can be maintained during the film formation, while in actual use, the layer B can be easily peeled off and only the thin retardation layer A can be subjected to various applications. The use of the thin retardation layer A can contribute to the thickness reduction of, for example, a polarizing plate and a liquid crystal display device, produced using the layer.

Specifically, means for solving the problems are as follows.

[1] A laminated film, comprising a retardation layer A (layer A) and a layer B that are formed through solvent co-casting, wherein

the layer A has a thickness of 5 μm or more and 30 μm or less;

the layer B has a higher tensile modulus compared to the layer A; and

an interlayer peeling force between the layer A and the layer B is 0.05 N/cm or more and 5 N/cm or less.

[2] The laminated film according to [1], wherein the layer B has a thickness d (μm) and an tensile modulus E′ (GPa) that satisfy the following expression.

30≦E′×d≦300

[3] The laminated film according to [1] or [2], wherein the layer A has refractive indices nx, ny, and nz that satisfy the following expression:

nz≧nx≧ny

wherein nx represents an in-plane refractive index in an in-plane slow axis direction, ny represents an in-plane refractive index in a direction perpendicular to the in-plane slow axis direction, and nz represents a refractive index in a thickness direction.
[4] The laminated film according to anyone of [1] to [3], wherein the layer B contains a cellulose ester as a main component.
[5] The laminated film according to anyone of [1] to [4], wherein the layer B contains a cellulose acetate that has a degree of acetyl substitution of 2.6 to 2.95 as a main component.
[6] The laminated film according to anyone of [1] to [5], wherein the layer A has a thickness of 13 μm or more and 25 μm or less.
[7] The laminated film according to anyone of [1] to [6], which has an tensile modulus difference ΔE′ between the layer A and the layer B of 0.4 GPa or more.
[8] The laminated film according to any one of [1] to [7], wherein the layer B has a thickness of 10 μm or more and 40 μm or less.
[9] The laminated film according to any one of [1] to [8], wherein the layer A contains at least one of an acrylic resin, a styrene-based resin, and a polyester-based resin, as a main component.
[10] The laminated film according to any one of [1] to [9], comprising an adhesive layer on the surface of the layer A that is not in contact with the layer B.
[11] A polarizing plate, comprising: the retardation layer A transferred from the laminated film according to any one of [1] to [10]; and a polarizing film.
[12] The polarizing plate according to [11], wherein the polarizing film has a thickness of 10 μm or less.
[13] A liquid crystal display device, comprising: the retardation layer A transferred from the laminated film according any one of [1] to [10]; or a polarizing plate according to [11] or [12].
[14] A method for producing an optical film, comprising bonding the retardation layer A with another film, when, after, or before the layer B is peeled from the laminated film according to any one of [1] to [10].
[15] The method according to [14], wherein the other film is a polarizing film or a retardation film.
[16] The method according to [14] or [15], further comprising reusing the layer B peeled as a material for forming the layer B in solvent co-casting to produce the laminated film.

According to the present invention, the deterioration of handling property occurring with the reduction of film thickness in solvent casting method can be overcome.

In addition, the present invention can provide a new laminated film which, during film formation through a solvent casting method, does not cause a problem of deterioration of handling property, and in use, which can be used in various applications as a thin retardation film. The present invention also can provide a polarizing plate and a liquid crystal display device which are produced using the laminated film and whose thicknesses can be reduced.

Furthermore, the present invention can provide a new method for producing an optical film using the laminated film of the present invention.

### BRIEF DESCRIPTION OF DRAWINGS

FIG. 1 is a cross sectional schematic diagram of one example of the laminated film of the invention.

FIG. 2 is a cross sectional schematic diagram of another example of the laminated film of the invention.

FIG. 3 is a cross sectional schematic diagram of still another example of the laminated film of the invention.

### DESCRIPTION OF EMBODIMENTS

The laminated film of the present invention and the production method therefor, and the polarizing plate and the liquid crystal display device using a retardation layer A obtained by peeling the layer A from the laminated film of the invention will be described in detail below.

The descriptions of the constitutional requirements given below are sometimes made based on typical embodiments of the present invention, but the present invention is not to be limited to such embodiments. Incidentally, a numerical range represented by “to” herein means a range including the numerical values written before and after the “to” as the lower limit and the upper limit, respectively.

### Laminated Film

The laminated film of the present invention (hereinafter, also referred to as film (optical film) of the invention) is a laminated film comprising a retardation layer A (layer A) and a layer B that are formed through solvent co-casting, wherein

the layer A has a thickness of 5 μm or more and 30 μm or less;

the layer B has a higher tensile modulus compared to the layer A; and

an interlayer peeling force between the layer A and the layer B is 0.05 N/cm or more and 5 N/cm or less.

Preferred embodiments of the film of the present invention will be described below.

### <Configuration of Film Layer>

### (Thickness of Layer A)

One characteristic of the laminated film of the invention is that the thickness of the layer A is small, specifically, 5 to 30 μm. Production of a thin film falling within the above range by a solvent casting method has involved a problem of break or the like during transportation on a support or during peeling from the support. In the present invention, a film is produced as a laminate along with a higher elastic layer B by solvent co-casting, whereby the deterioration in handling property associated with the reduction in film thickness is overcome. A smaller thickness of the layer A is more preferred from the viewpoint of the thickness reduction of devices. However, too small thickness may result in the reduction of effect of the lamination with the layer B, and from these viewpoints, the thickness is preferably 8 to 28 μm, and more preferably 13 to 25 μm.

### (Thickness of Layer B)

The thickness of the layer B is not particularly limited. In order to improve the handling property of the laminated film, the thickness is preferably 10 μm or more, and more preferably 20 μm or more. On the other hand, in view of discarding the material as a layer for the lamination, a smaller thickness is preferred, and, for example, the thickness is preferably 40 μm or less, and more preferably 35 μm or less.

### (Thickness of Laminated Film)

The total thickness of the laminated film including the layer A and the layer B is also not particularly limited. From the viewpoint of improving handling property, the total thickness is preferably 20 μm or more and 200 μm or less, more preferably 20 μm or more and 180 μm or less, especially preferably 30 μm or more and 150 μm or less, and most preferably 40 μm or more and 100 μm or less.

### (Interlayer Peeling Force)

The laminated film of the invention exhibits an interlayer peeling force between the layer A and the layer B of 0.05 to 5 N/cm. Owing to the interlayer peeling force falling within the above range, the laminated film maintains a good adhesiveness enough not to cause peeling during the film formation, whereas in use, the laminated film exhibits a good peeling property which allows for peeling the layer A from the layer B with ease to use the layer A singly. Thus, the laminated film can maintain a good handling property during film formation through a solvent casting method, and in use, the layer A can be detached from the layer B such that the layer A can be used singly in various applications. The interlayer peeling force between the layer A and the layer B is preferably 0.1 to 4 N/cm, and more preferably 0.2 to 3 N/cm.

The interlayer peeling force between the layer A and the layer B is affected by affinity between polymers (this term is used with a meaning including both polymerized product and resin, and hereinafter the same is applied) that are respectively used in the layer A and the layer B as main components. When components that have higher affinity with each other are used as main components of layers, the adhesion between the layers is higher, that is, the interlayer peeling force therebetween becomes larger. On the other hand, components that have lower affinity with each other are used as main components of layers, the adhesion between layers is lower, that is, the interlayer peeling force therebetween becomes smaller. When an acrylic resin, a styrene-based resin, a polyester resin, or a polycarbonate as described later or the like is used as a main component of the layer A, the interlayer peeling force can be adjusted into the above-mentioned range by using a material with a certain high level of hydrophilicity, such as cellulose ester, as a main component of the layer B. In addition, the interlayer peeling force can be adjusted into the above-mentioned range also by controlling the kind and amount of the additive to be added to each layer, as well as of the main component thereof. Furthermore, the interlayer peeling force can be adjusted also by the kind or composition of the solvent in the dope for forming each layer used during the film formation through a solvent casting method.

(Tensile modulus of Layers)

The layer B is a layer having a higher tensile modulus compared to the layer A. By forming the layer A along with the layer B having such a characteristic through co-casting, the deterioration of handling property of the layer A due to the thickness reduction can be reduced. When the difference ΔE′ in tensile modulus E′ (GPa) between the layer B and the layer A is 0.2 GPa or more, the above effect can be achieved, and ΔE′ is preferably 0.4 GPa or more. For example, the tensile modulus of a cellulose acetate is approximately 3.0 GPa or more, and a higher degree of acetyl substitution tends to provide a higher tensile modulus of the film containing the material as a main component. The tensile modulus of the film containing, as a main component, an acrylic resin, a styrene-based resin, and a polyester-based resin which is exemplified as a main component of the layer A is approximately 2.0 GPa. When using a cellulose acetate whose degree of acetyl substitution is 2.6 or more, it is possible to form the layer B that has a higher tensile modulus than that of the layer A containing the above-mentioned resin as a main component.

In terms of improving handling property, the thickness d (μm) and the tensile modulus E′ (GPa) of the layer B preferably satisfy the following expression:

30≦E′×d≦300

and, more preferably satisfy the following expression.

40≦E′×d≦250

### (Aspect of Lamination)

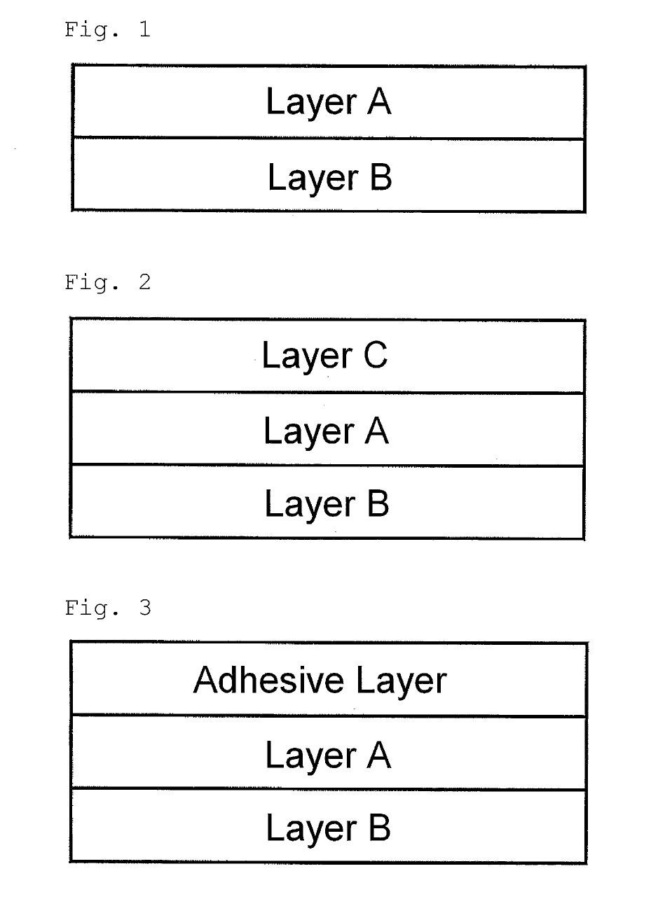

As shown in the cross sectional schematic diagram of FIG. 1, the laminated film of the invention may have a two-layer structure composed of the layer A and the layer B. Alternatively, the laminated film may have a lamination structure composed of 3 or more layers including one or more layers other than the layer A and the layer B. One example thereof is shown in the cross sectional schematic diagram of FIG. 2. FIG. 2 shows an example of three-layer structure including the layer A in the center, and the layer B and a layer C disposed respectively on the upper and lower sides of the layer A. The layer C may be made of the same composition as the layer B, or may be made of a different composition (a composition which is different in kind of the polymer as a main component, kinds of additives, or proportions thereof) from the layer B. In addition, similar to the layer B, the layer C may be a layer that contributes to improvement of the handling property, may be a protective layer for the layer A (such as, for example, a protective layer for preventing the surface of the layer A from getting dust and dirt, or a protective layer for preventing the surface of the layer A from being scratched), or may be a layer having both of these functions. The layer C may be peeled from the layer A, during, before or after the peeling of the layer B, or depending on the intended use, may be subjected to the use as a laminate of the layer A and the layer C. The layer C may be formed simultaneously along with the layer A and the layer B through co-casting, or may be formed, after producing a laminated film composed of the layer A and the layer B through co-casting, by separately bonding a film or the like that becomes the layer C with the resulting laminated film.

An adhesive layer may be formed on the surface of the layer A, the adhesive layer being used upon bonding the layer A with another member. A cross sectional schematic diagram of one example of an aspect comprising an adhesive layer is shown in FIG. 3. The example shown in FIG. 3 is one comprising an adhesive layer formed on the surface of the layer A of the laminated film composed of the layer A and the layer B produced through co-casting, by coating the surface. The adhesive layer may be utilized for bonding the layer A with another member (for example, a polarizer, a retardation film, or a liquid crystal cell), when, before, or after the layer A is peeled from the layer B. Upon storage, transportation, or the like before the use, a release film may be laminated on the surface of the adhesive layer to protect the adhesive surface.

### (Film Width)

The width of the laminated film of the invention is preferably 400 to 2500 mm, more preferably 1000 mm or more, especially preferably 1500 mm or more, and further especially preferably 1800 mm or more.

### (Film Length)

The laminated film of the invention may be in a form of a continuously produced long belt or in a form of a roll in which the long belt is wound into a roll, or may be, for example, cut into a shape suitable for practical use, such as a strip or other forms.

Next, the properties of each layer in the laminated film of the invention, and the material and method usable for the production thereof will be described in detail.

### <Layer A>

The layer A is a retardation layer that has any optical properties. The optical properties may be determined depending on the use purpose. One example thereof is a retardation layer in which the refractive indices nx, ny, and nz satisfy the following expression:

nz≧nx≧ny

wherein, nx represents an in-plane refractive index in an in-plane slow axis direction, ny represents an in-plane refractive index in a direction perpendicular to the in-plane slow axis direction, and nz represents a refractive index in a thickness direction.

Examples of the retardation layer satisfying the above expression include a retardation layer that satisfies the following expression.

nz>nx≧ny

Examples of the retardation layer satisfying the above expression include a so-called positive C-plate (which, as used herein, means not only the positive C-plate in a strict sense but also includes any retardation plates that act like C-plate, and specifically, which means a retardation plate in which Rth is a negative value and Re is 0 to 10 nm) and a so-called positive B-plate (which, as used herein, means an optically biaxial retardation plate and includes any optically biaxial retardation plate wherein Rth is a negative value). The layer A satisfying the above characteristics is useful as, for example, a viewing angle compensation film in a liquid crystal display device of a horizontal orientation mode, such as an IPS mode, an FFS mode, etc.

For allowing the layer A to act as a positive C-plate, a positive B-plate, or the like and to contribute to the viewing angle compensation of a liquid crystal display device of a horizontal orientation mode, the Rth needs to be a negative value having a certain large absolute value. On the other hand, since the layer A is a thin layer having a thickness falling within the above-mentioned range, it is preferred that the layer A contains a material that has a high ability to develop Rth as a main component. Examples of the main component usable for forming the layer A that satisfies the above optical properties include an acrylic resin, a styrene-based resin and a polyester-based resin. These are, as it is called, materials having a negative intrinsic birefringence. Incidentally, the main component means a component whose content (% by mass) is the largest among the components constituting the layer.

These resins will be described below.

### (Acrylic Resin)

Acrylic resins usable as the main component of the layer A preferably have a number average molecular weight of 1000 or more and less than 2000000, more preferably 5000 to 1000000, and still more preferably 8000 to 500000.

Examples of the acrylic resin include a polymer containing a constitutional unit obtained from acrylic acid ester-based monomer represented by the following general formula (2).

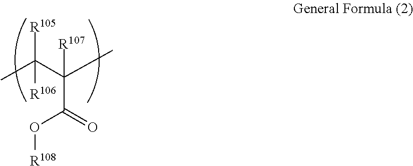

In the formula, R¹⁰⁵ to R¹⁰⁸ each independently represent a substituted or unsubstituted hydrocarbon group having 1 to 30 carbon atoms or a polar group, which may have a linking group including a hydrogen atom, a halogen atom, an oxygen atom, a sulfur atom, a nitrogen atom, or a silicon atom.

Examples of the acrylic acid ester-based monomer include methyl acrylate, ethyl acrylate, (i-, n-)propyl acrylate, (n-, i-, s-, tert-) butyl acrylate, (n-, i-, s-) pentyl acrylate, (n-, i-)hexyl acrylate, (n-, i-)heptyl acrylate, (n-, i-)octyl acrylate, (n-, i-)nonyl acrylate, (n-, i-)myristyl acrylate, 2-ethylhexyl acrylate, ε-caprolactone acrylate, 2-hydroxyethyl acrylate, 2-hydroxypropyl acrylate, 3-hydroxypropyl acrylate, 4-hydroxybutyl acrylate, 2-hydroxybutyl acrylate, 2-methoxyethyl acrylate, 2-ethoxyethyl acrylate, phenyl acrylate, phenyl methacrylate, (2- or 4-chlorophenyl)acrylate, (2- or 4-chlorophenyl) methacrylate, (2-, 3-, or 4-ethoxycarbonylphenyl)acrylate, (2-, 3-, or 4-ethoxycarbonylphenyl)methacrylate, (o-, m-, or p-tolyl)acrylate, (o-, m-, or p-tolyl)methacrylate, benzyl acrylate, benzyl methacrylate, phenethyl acrylate, phenethyl methacrylate, 2-naphthyl acrylate, cyclohexyl acrylate, cyclohexyl methacrylate, 4-methylcyclohexyl acrylate, 4-methylcyclohexyl methacrylate, 4-ethylcyclohexyl acrylate, 4-ethylcyclohexyl methacrylate, etc., and a compound obtained by changing the acrylic acid ester into methacrylic acid ester, but the present invention is not limited to these specific examples. Two or more of these monomers may be used as components for co-polymerization. Among them, methyl acrylate, ethyl acrylate, (i-, n-)propyl acrylate, (n-, s-, tert-)butyl acrylate, (n-, s-)pentyl acrylate, (n-, i-)hexyl acrylate, or a compound obtained by changing the acrylic acid ester into methacrylic acid ester is preferred in terms of industrial availability and low price.

Commercially available compounds, for example, “Dianal BR88” (from Mitsubishi Rayon), etc. may be used.

### (Styrene-based Resin)

Examples of the Styrene-based resin usable as the main component of the layer A include polystyrene derivatives and styrene-based copolymers. Specifically, homopolymer and copolymer of styrene-based monomer are included. The styrene-based copolymer may be a copolymer of two or more kinds of styrene-based monomer, or a copolymer of one or more kinds of styrene-based monomer and one or more kinds of non-styrene-based monomer (for example, an acrylic monomer, and preferably an acrylic monomer represented by the formula (c) described below).

Examples of the styrene-based monomer include a monomer obtained by replacing one or more hydrogen atoms on the ethenyl group in styrene by a substituent, and a monomer obtained by replacing one or more hydrogen atoms on the phenyl group in styrene by a substituent. A styrene-based monomer having a substituent on the phenyl group is preferred. As the substituent, an alkyl group, a halogen atom, an alkoxy group, a carboxy group such as acetoxy group, an amino group, a nitro group, a cyano group, an aryl group, a hydroxy group, and a carbonyl group are exemplified, and a hydroxy group, a carbonyl group or an acetoxy group is preferred, and a hydroxy group or an acetoxy group is more preferred. The substituents may be present alone or in combination of two or more thereof. In addition, the substituents may or may not have a further substituent. Furthermore, the styrene-based derivative monomer may be one in which a phenyl group and another aromatic ring are fused together, may be an indene or an indan in which the substituents form a ring other than the phenyl group, or may have a structure having a crosslinked ring.

The styrene-based monomer is preferably an aromatic vinyl-based monomer represented by the following general formula (b).

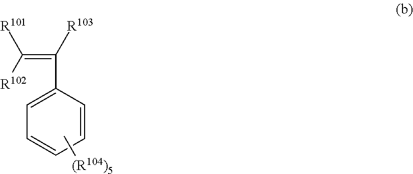

In the formula, R¹⁰¹ to R¹⁰⁴ each independently represent a substituted or unsubstituted hydrocarbon group having 1 to 30 carbon atoms or a polar group, which may have a linking group including a hydrogen atom, a halogen atom, an oxygen atom, a sulfur atom, a nitrogen atom or a silicon atom, and all of R¹⁰⁴s may be the same atom or group, or R¹⁰⁴s may be different atoms or groups from each other, or may be bound to each other to form a carbon ring or a hetero ring (the carbon ring and hetero ring may have a single ring structure or may form a polycyclic structure in which the ring is fused with other rings).

Specific examples of the aromatic vinyl-based monomer include: styrene; alkyl-substituted styrenes, such as α-methylstyrene, β-methylstyrene, and p-methylstyrene; halogen-substituted styrenes, such as 4-chlorostyrene and 4-bromostyrene; hydroxystyrenes, such as p-hydroxystyrene, α-methyl-p-hydroxystyrene, 2-methyl-4-hydroxystyrene, and 3,4-dihydroxystyrene; vinylbenzyl alkohols; alkoxy-substituted styrenes, such as p-methoxystyrene, p-tert-butoxystyrene, and m-tert-butoxystyrene; vinylbenzoic acids, such as 3-vinylbenzoic acid and 4-vinylbenzoic acid; vinylbenzoic acid esters, such as methyl 4-vinylbenzoate and ethyl 4-vinylbenzoate; 4-vinylbenzyl acetate; 4-acetoxystyrene; amidostyrenes, such as 2-butyramidostyrene, 4-methylamidostyrene, and p-sulfonamidostyrene; aminostyrenes, such as 3-aminostyrene, 4-amionstyrene, 2-isopropenylaniline, and vinylbenzyldimethylamine; nitrostyrenes, such as 3-nitrostyrene and 4-nitrostyrene; cyanostyrenes, such as 3-cyanostyrene and 4-cyanostyrene; vinylphenylacetonitrile; arylstyrenes, such as phenylstyrene; and indenes, but the present invention is not limited to these specific examples. Two or more of these monomers may be used as components for copolymerization.

The acrylic monomer may be selected from monomers represented by the following formula (c).

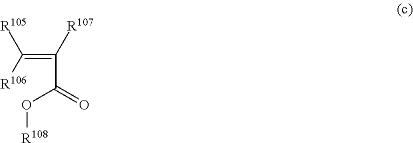

In the formula, R¹⁰⁵ to R¹⁰⁸ each independently represent a substituted or unsubstituted hydrocarbon group having 1 to 30 carbon atoms, or a polar group, which may have a linking group including a hydrogen atom, a halogen atom, an oxygen atom, a sulfur atom, a nitrogen atom, or a silicon atom.

Examples of the acrylic acid ester-based monomer include methyl acrylate, ethyl acrylate, (i-, n-)propyl acrylate, (n-, i-, s-, tert-)butylacrylate, (n-, s-)pentyl acrylate, (n-, i-)hexyl acrylate, (n-, i-)heptyl acrylate, (n-, i-)octyl acrylate, (n-, i-)nonyl acrylate, (n-, i-)myristyl acrylate, 2-ethylhexyl acrylate, ε-caprolactone acrylate, 2-hydroxyethyl acrylate, 2-hydroxypropyl acrylate, 3-hydroxypropyl acrylate, 4-hydroxybutyl acrylate, 2-hydroxybutyl acrylate, 2-methoxyethyl acrylate, 2-ethoxyethyl acrylate, phenyl acrylate, phenyl methacrylate, (2-, or 4-chlorophenyl)acrylate, (2-, or 4-chlorophenyl) methacrylate, (2-, 3-, or 4-ethoxycarbonylphenyl)acrylate, (2-, 3-, or 4-ethoxycarbonylphenyl)methacrylate, (o-, m-, or p-tolyl)acrylate, (o-, m-, or p-tolyl)methacrylate, benzyl acrylate, benzyl methacrylate, phenethyl acrylate, phenethyl methacrylate, 2-naphthyl acrylate, cyclohexyl acrylate, cyclohexyl methacrylate, 4-methylcyclohexyl acrylate, 4-methylcyclohexyl methacrylate, 4-ethylcyclohexyl acrylate, 4-ethylcyclohexyl methacrylate, etc., and a compound obtained by changing the above acrylic acid ester into methacrylic acid ester, but the present invention is not limited to the specific examples. Two or more of these monomers can be used as a components for copolymerization. Among them, methyl acrylate, ethyl acrylate, (i-, n-)propyl acrylate, (n-, s-, tert-)butyl acrylate, (n-, s-)pentyl acrylate, (n-, i-)hexyl acrylate, or the compound obtained by changing the acrylic acid ester into methacrylic acid ester is preferred in terms of industrial availability and low price.

In addition, the other component for the copolymerization includes, but not limited to, anhydrides, such as maleic anhydride, citraconic anhydride, cis-1-cyclohexene-1,2-dicarboxylic acid anhydride, 3-methyl-cis-1-cyclohexene-1,2-dicarboxylic acid anhydride, and 4-methyl-cis-1-cyclohexene-1,2-dicarboxylic acid anhydride; nitrile group-containing radical polymerizable monomers, such as acrylonitrile and methacrylonitrile; an amide bond-containing radical polymerizable monomers, such as acrylamide, methacrylamide, and trifluoromethanesulfonylaminoethyl (meth)acrylate; fatty acid vinyl esters, such as vinyl acetate; chlorine-containing radical polymerizable monomers, such as vinyl chloride and vinylidene chloride; conjugated diolefins, such as 1,3-butadiene, isoprene, and 1,4-dimethylbutadiene.

### (Polyester Resin)

As the polyester resin to be used as a main component of the layer A, exemplified is a fumaric acid ester-based resin which is known as a material having a negative intrinsic birefringence, described in, for example, JP-A 2008-112141. The fumaric acid ester-based resin may include fumaric acid ester polymers, and among them, a fumaric acid diester resin which comprises 50% by mole or more of fumaric acid diester residue unit represented by the general formula (a) is preferred.

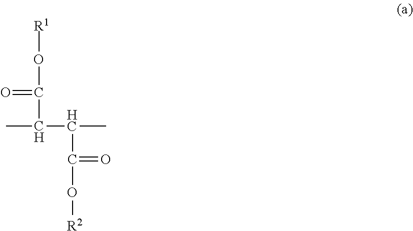

R¹ and R² each independently represent a branched alkyl group or cyclic alkyl group having 3 to 12 carbon atoms.

R¹ and R² which each are an ester substituent to the fumaric acid diester residue unit are each independently a branched alkyl group or cyclic alkyl group having 3 to 12 carbon atoms, and are optionally substituted by a halogen group, such as fluorine and chlorine, an ether group, an ester group, or an amino group. Examples thereof include an isopropyl group, an s-butyl group, a t-butyl group, an s-pentyl group, a t-pentyl group, an s-hexyl group, a t-hexyl group, a cyclopropyl group, a cyclopentyl group, and a cyclohexyl group. An isopropyl group, an s-butyl group, a t-butyl group, a cyclopentyl group, a cyclohexyl group, etc. are preferred, and an isopropyl group is more preferred.

Examples of the fumaric acid diester residue unit represented by the general formula (a) include a diisopropyl fumarate residue, a di-s-butyl fumarate residue, a di-t-butyl fumarate residue, a di-s-pentyl fumarate residue, a di-t-pentyl fumarate residue, a di-s-hexyl fumarate residue, a di-t-hexyl fumarate residue, a dicyclopropyl fumarate residue, a dicyclopentyl fumarate residue, a dicyclohexyl fumarate residue. A diisopropyl fumarate residue, a di-s-butyl fumarate residue, a di-t-butyl fumarate residue, a dicyclopentyl fumarate residue, a dicyclohexyl fumarate residue, etc. are preferred, and a diisopropyl fumarate residue is especially preferred.

As a main component of the layer A, a fumaric acid ester-based resin comprising 50% by mole or more of fumaric acid diester residue unit represented by the general formula (a) is preferably used, and a resin comprising 50% by mole or more of a fumaric acid diester residue unit represented by the general formula (a) and 50% by mole or less of a residue unit derived from a monomer copolymerizable with a fumaric acid diester. As the residue unit derived from a monomer copolymerizable with a fumaric acid diester, exemplified are one, or two or more of, for example, styrene-based residues, such as a styrene residue and an α-methylstyrene residue; an acrylic acid residue; acrylic acid ester residues, such as a methyl acrylate residue, an ethyl acrylate residue, a butyl acrylate residue, a 3-ethyl-3-oxetanylmethyl acrylate residue, a tetrahydrofurfuryl acrylate residue; a methacrylic acid residue; methacrylic acid ester residues, such as a methyl methacrylate residue, an ethyl methacrylate residue, a butyl methacrylate residue, a 3-ethyl-3-oxetanylmethyl methacrylate residue, and a tetrahydrofurfuryl methacrylate residue; vinyl ester residues, such as a vinyl acetate residue and a vinyl propionate residue; an acrylonitrile residue; a methacrylonitrile residue; olefin residues, such as an ethylene residue and a propylene residue. Among them, a 3-ethyl-3-oxetanylmethyl acrylate residue, and a 3-ethyl-3-oxetanylmethyl methacrylate residue are preferred, and a 3-ethyl-3-oxetanylmethyl acrylate residue is especially preferred. Among them, a resin comprising 70% by mole or more of the fumaric acid diester reside unit represented by the general formula (a) is preferred, a resin comprising 80% by mole or more of the fumaric acid diester reside unit is more preferred, and a resin comprising 90% by mole or more of the fumaric acid diester reside unit is still more preferred. Of course, a resin constituted only of the fumaric acid diester residue unit represented by the general formula (a) is also preferred.

The fumaric acid ester-based resin to be used as a main component of the layer A preferably has 1×10⁴ or more of a number average molecular weight (Mn) in terms of standard polystyrene obtained from an elution curve as measured by gel permeation chromatography (hereinafter abbreviated to GPC). The number average molecular weight is especially preferably 2×10⁴ or more and 2×10⁵ or less, since a retardation layer A having good mechanical properties and achieving good moldability in film formation can be attained.

The production method of the fumaric acid ester-based resin is not particularly limited, and various methods can be adopted. For example, the fumaric acid ester-based resin can be produced by radical polymerization or radical copolymerization of a fumaric acid diester, optionally in combination with a monomer copolymerizable with the fumaric acid diester. Examples of the fumaric acid diester to be used as the raw material include diisopropyl fumarate, di-s-butyl fumarate, di-t-butyl fumarate, di-s-pentyl fumarate, di-t-pentyl fumarate, di-s-hexyl fumarate, di-t-hexyl fumarate, dicyclopropyl fumarate, dicyclopentyl fumarate, and dicyclohexyl fumarate. As the monomer copolymerizable with the fumaric acid diester, mentioned are one or more of, for example, styrenes, such as styrene and α-methylstyrene; acrylic acid; acrylic acid esters, such as methyl acrylate, ethyl acrylate, butyl acrylate, 3-ethyl-3-oxetanylmethyl acrylate, and tetrahydrofurfuryl acrylate; methacrylic acid; methacrylic acid esters, such as methyl methacrylate, ethyl methacrylate, butyl methacrylate, 3-ethyl-3-oxetanylmethyl methacrylate, and tetrahydrofurfuryl methacrylate; vinyl esters, such as vinyl acetate and vinyl propionate; acrylonitrile; methacrylonitrile; olefins, such as ethylene and propyrene. Among them, 3-ethyl-3-oxetanylmethyl acrylate or 3-ethyl-3-oxetanylmethyl methacrylate is preferred, and 3-ethyl-3-oxetanylmethyl acrylate is especially preferred.

As the radical polymerization method, known polymerization methods can be used. For example, any of bulk polymerization method, solution polymerization method, suspension polymerization method, precipitation polymerization method, and emulsion polymerization method can be adopted.

Examples of polymerization initiator in the radical polymerization include organic peroxides, such as benzoyl peroxide, lauryl peroxide, octanoyl peroxide, acetyl peroxide, di-t-butyl peroxide, t-butylcumyl peroxide, dicumyl peroxide, t-butyl peroxyacetate, t-butyl peroxybenzoate, and t-butyl peroxypivalate; and azo-based initiators, such as 2,2′-azobis(2,4-dimethylvaleronitrile), 2,2′-azobis(2-butyronitrile), 2,2′-azobisisobutyronitrile, dimethyl-2,2′-azobisisobutyrate, and 1,1′-azobis(cyclohexane-1-carbonitrile).

Solvent to be used in the solution polymerization method, suspension polymerization method, precipitation polymerization method, or emulsion polymerization method is not particularly limited, and examples thereof include aromatic solvents, such as benzene, toluene, and xylene; alcohol solvents, such as methanol, ethanol, propyl alcohol, and butyl alcohol; cyclohexane; dioxane; tetrahydrofuran (THF); acetone; methyl ethyl ketone; dimethylformamide; isopropyl acetate; and water, and mixture solvents thereof are also included.

The temperature for the radical polymerization can be set appropriately according to the decomposition temperature of the polymerization initiator, and in general, the polymerization is preferably carried out at a temperature in the range of 40 to 150° C.

### (Other Polymer)

Other polymers than the above resin may be used for formation of the layer A. Any polymer material can be used which gives an interlayer peeling force relative to the layer B used in combination within the above-mentioned range and which can be made into a film by solvent casting method. The index for selecting a component which gives an interlayer peeling force within the above-mentioned range is ASP value. The SP value is to mean a parameter value of solubility calculated by the Hoy method. The Hoy method is described in Polymer Handbook, 4th edition. A larger absolute value (|SPA−SPB|) of the difference of the respective SP values (SPA and SPB) of the layer A and the layer B calculated based on the Hoy method corresponds to a lower affinity, that is, to a smaller interlayer peeling force, whereas a smaller ΔSP value corresponds to a higher affinity, that is, to a larger interlayer peeling force. In order to make the interlayer peeling force between the layer A and the layer B within the above-mentioned range, the ΔSP value is preferably 1 or more, more preferably 1 to 5. For example, in an aspect in which a cellulose ester is used as the layer B, examples of the other polymer material capable of being used for formation of the layer A which provides an interlayer peeling force within the above-mentioned range include a polycarbonate, etc., but the present invention is not limited to these examples.

### (Additive in Layer A)

One or more surfactants can be added into the layer A. As for examples of the usable additive and the preferred range of the addition amount thereof, reference may be made to [0033] to [0041] of JP-A 2009-168900.

### <Layer B>

The material to be used for forming the layer B is not particularly limited, and usable is any material which can be made into the layer B, by a solvent casting method, that gives the interlayer peeling force relative to the layer A within the above-mentioned range and that has a high tensile modulus. Cellulose ester is a polymer material which is made into a film by a solvent casting method and preferred as a main component of the layer B. The cellulose ester as a main component of the layer B will be described below, but it is not intended to limit the main component of the layer B to cellulose ester.

### (Cellulose Ester)

The cellulose ester usable for the formation of the layer B is a material obtained by substituting at least a part of OH groups in the cellulose molecule of the raw material with ester groups. As the raw material cellulose, those from cotton linter, wood pulp (hardwood pulp, softwood pulp), etc. are exemplified, and cellulose acylate derived from any raw material cellulose may be used, optionally as a mixture thereof. Detailed descriptions of these raw material celluloses are found in, for example, Marusawa and Uda, “Plastic Zairyo Koza (17) Senisokei jushi (Plastic Material Lecture (17), Cellulose Resin)” (1970), The Nikkan Kogyo Shimbun, Ltd., or Japan Institute of Invention and Innovation, Kokai Giho Gogi Number 2001-1745 (pp. 7-8).

The cellulose ester is preferably an aliphatic ester, that is, an ester having an aliphatic acyl group. Examples of the aliphatic acyl group include an acetyl group, a propynyl group, and a butynyl group. Examples of usable cellulose ester include cellulose acetate, cellulose acetate propionate, cellulose acetate butyrate, cellulose acetate benzoate, cellulose propionate, and cellulose butyrate. More preferably included are cellulose acetate and cellulose acetate propionate, and still more preferably is cellulose acetate. When a cellulose acetate having a degree of substitution with acetyl groups of 2.6 to 2.95 (more preferably, 2.7 to 2.91) is used, the layer B that gives an interlayer peeling force within the above-mentioned range relative to the layer A containing the acrylic resin, styrene-based resin, or polyester-based resin mentioned above as a main component and that has a high tensile modulus can be preferably formed by a solvent casting method.

The degree of substitution with acetyl groups or degree of substitution with the other acyl groups can be determined by the method defined in ASTM-D817-96.

The weight average molecular weight (Mw) of the cellulose ester to be used in the present invention is preferably 75000 or more, more preferably 75000 to 300000, still more preferably 100000 to 240000, and especially preferably 160000 to 240000, from the viewpoint of the film forming property by the solvent casting method, and the like.

The layer B may contain one or more additives, such as a plasticizer, a mat agent, and a UV absorber, in addition to the above-mentioned main component. The layer C described below may also contain one or more additives.

### <Layer C>

The laminated film of the invention may comprise one or more other layers, layers C, which are formed by co-casting along with the layer A and the layer B. As shown in FIG. 2, for example, the layer C may be formed on the surface of the layer A opposite to the lamination surface with the layer B. Alternatively, the layer C may be laminated on the surface of the layer B. The layer C may be a layer contributing to improvement of the handling property similar to the layer B, may be a protective layer for the layer A (such as, for example, a protective layer for preventing the surface of the layer A from getting dust and dirt, or a protective layer for preventing the surface of the layer A from being scratched), or may be a layer having both of these functions. The layer C may be peeled from the layer A, during, before or after the peeling of the layer B. In this aspect, the main component to be used for forming the layer C is preferably the same as that of the layer B, and, for example, a cellulose acetate having a degree of substitution with acetyl groups of 2.6 to 2.95 may be used. Depending on the intended use, the layer A and the layer C may be made into a laminate to be subjected to the use. In this case, materials thereof may be variously selected to satisfy the desired properties depending on the intended use.

Incidentally, the layer C may be simultaneously formed along with the layer A and the layer B through co-casting, or may be formed, after producing a laminated film composed of the layer A and the layer B through co-casting, by separately bonding a film or the like that becomes the layer C on the laminated film. Examples of the film that can be bonded include various generally-used films, such as a cellulose ester film, a polycarbonate film, a polyethylene terephthalate film, a polyimide film, a polymer liquid crystal film, and a cyclic olefin film.

The thickness of the layer C is not particularly limited. The thickness may be determined depending on the intended use. As shown in FIG. 2, in the aspect in which the layer C is laminated on a surface of the layer A and the layer A is to be used after the layer C is peeled form the layer A, the interlayer peeling force between the layer A and the layer C is preferably 0.05 to 5 N/cm, as with that between the layer A and the layer B.

### <Adhesive Layer>

The laminated film of the invention may comprise an adhesive layer. The adhesive layer is utilized for, for example, bonding the layer A with another member (for example, a polarizer, another retardation film, a polarizing plate protective film, a liquid crystal cell, etc.). The adhesive layer may be formed, for example, on the surface of the layer A opposite to the laminated surface with the layer B. Optionally, a release film may be laminated on the surface of the adhesive layer upon storage, transport, or the like prior to the use, to protect the adhesive surface.

The material that can be used to form the adhesive layer is not particularly limited. Specifically, the adhesive described in JP-A 2011-37140, etc. may be used.

### Production Method of Laminated Film

The laminated film of the invention may be formed by a solvent casting method. More specifically, the laminated film can be produced by forming the layer A, the layer B, and, as desired, the other layer C, through solvent co-casting. The solvent co-casting method is not particularly limited and the solvent co-casting may be carried out using various apparatuses, conditions, and the like used for conventional solvent co-casting.

### <Preparation of Dope>

In the solvent co-casting method, a solution (dope) for forming each layer is prepared. The dope can be prepared by dissolving materials for forming each layer in an organic solvent. For the preparation of the solution (dope), the dissolving may be performed by a room temperature dissolving method, a cooling dissolving method, a high temperature dissolving method, or a combination of these methods. In this respect, reference may be made to the methods of preparing cellulose acylate solution described in, for example, JP-A 5-163301, JP-A 61-106628, JP-A 58-127737, JP-A 9-95544, JP-A 10-95854, J9-A 10-45950, JP-A 2000-53784, JP-A 11-322946, JP-A 11-322947, JP-A2-276830, JP-A2000-273239, JP-A11-71463, JP-A 04-259511, JP-A2000-273184, JP-A11-323017, and JP-A 11-302388. For details of them, in particular, of the chlorine free solvent-system, reference may be made to the method described in detail in pp. 22-25 of the above-mentioned Kokai Giho No. 2001-1745. In addition, the dope solution is generally subjected to solution concentration and filtration, and these procedures are also described in detail in p. 25 of the Kokai Giho No. 2001-1745. Incidentally, in the case where the dissolving is performed at a high temperature, the temperature is mostly higher than the boiling point of the organic solvent used, and in this case, the solvent may be used in a pressurized condition.

### (Organic Solvent)

The organic solvent to be used for preparation of the dope for use in the formation of each layer is not particularly limited. A suitable solvent may be selected depending on the solubility of the material for the film forming, or the like, from among various organic solvents, such as chlorides of lower aliphatic hydrocarbons, lower aliphatic alcohols, ketones having 3 to 12 carbon atoms, esters having 3 to 12 carbon atoms, ethers having 3 to 12 carbon atoms, aliphatic hydrocarbons having 5 to 8 carbon atoms, aromatic hydrocarbons having 6 to 12 carbon atoms, and fluoroalcohols (for example, compounds described in JP-A 8-143709, paragraph [0020]; JP-A 11-60807, paragraph [0037]; etc.).

The solvents may be used singly or in combination, but preferably used as a mixture of a good solvent and a poor solvent in order to impart a plane stability, and more preferably, the mixing ratio of the good solvent and the poor solvent is 60 to 99% by mass of good solvent and 40 to 1% by mass of poor solvent. In the present invention, good solvent means a solvent that can singly dissolve the resin to be used and poor solvent means one that singly swells or can not dissolve the resin to be used. Examples of the good solvent include organic halogen compounds such as methylene chloride, and dioxolanes. As the poor solvent, for example, methanol, ethanol, n-butanol and cyclohexane are preferably used.

Among the organic solvents, the proportion of alcohols is preferably 10 to 50% by mass of the total organic solvents for the reason that the time period for drying the film formed on a support (a casting substrate) can be reduced and the film can be peeled off and dried soon. The proportion is more preferably 15 to 30% by mass.

### (Total Solid Concentration of Dope)

The materials forming each layer are preferably dissolved in an organic solvent at a total solid concentration (sum of components that become solid after drying) of 10 to 60% by mass, and more preferably of 10 to 50% by mass. In the case where a cellulose ester is a main component, the materials are preferably dissolved at a total solid concentration of 10 to 30% by mass, more preferably of 15 to 25% by mass, and most preferably of 18 to 20% by mass. Depending on the intended use, however, even the total solid concentration of the dope of more than 20% by mass and 22% by mass or less may be preferred for the reason that, for example, the content of the organic solvent, and thus the time period required for drying, can be reduced. As for the method of preparing a dope having the above total solid concentration, the preparation may be conducted such that a predetermined total solid concentration is attained in the dissolving step, or a solution having a lower content (for example, 9 to 14% by mass) may be previously prepared and then adjusted to a predetermined higher content in a concentration step. Furthermore, it is possible that a solution having a higher content of the material for forming an optically transparent base material is previously prepared and then various additives are added thereto to give a solution having a predetermined lower content.

From the viewpoint of achieving support releasing property, interface adhesiveness, and low carling, as for the composition of the polymer material as the main component in the dope, for example, in the case of a dope containing a cellulose ester, the proportion occupied by the cellulose ester is preferably 50 to 100% by mass, more preferably 70 to 100% by mass, and most preferably 80 to 100% by mass. In the case of a dope containing an acrylic resin or the like, the proportion occupied by the acrylic resin is preferably 30 to 100% by mass, more preferably 50 to 100% by mass, and most preferably 70 to 100% by mass.

On the other hand, in order to obtain a good planer film through co-casting film formation, differences in total solid concentration between dopes for forming respective layers are preferably 10% by mass or less, and more preferably 5% by mass or less.

In particular, it is preferred that the total solid concentration in the dope for forming the layer B is 16 to 30% by mass, and the differences in total solid concentration between dopes for forming the respective layers are 10% by mass or less.

### <Co-casting Step>

### (Casting)

The laminated film of the invention can be produced by a process having a step of casting a dope for the layer A (hereinafter, sometimes referred to as dope A), a dope for the layer B (hereinafter, sometimes referred to as dope B), and, as desired, a dope for the layer C (hereinafter, referred to as dope C) into a laminate on a casting support by a co-casting method. The co-casting may be carried out with the dope A on the support, and the dope B thereon, or with the dope B on the support, and the dope A thereon.

Each dope casted on the support may be dried on the support, and formed into a film while the solvent is evaporated. The support used herein is not particularly limited, but preferably a drum or a band. The surface of the support is preferably finished into a mirror state. Casting and drying methods in the solvent casting method are described in U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, GB640731, GB736892, JP-B 45-4554, JP-B 49-5614, JP-A 60-176834, JP-A 60-203430, and JP-A 62-115035.

In the present invention, two or more dopes are casted on the casting support to form a film. The method for forming a film of the present invention is otherwise not particularly limited, and any co-casting method may be used. For example, dope solutions may be allowed to respectively flow for casting out of a plurality of outlets provided at intervals in the travelling direction of a metal support to laminate the dopes into a film, and the methods described in, for example, JP-A 61-158414, JP-A 1-122419, and JP-A 11-198285 can be applied. Alternatively, dopes may be formed into a film by allowing the dope solutions to flow for casting out of two outlets, and the film formation can be performed by methods described in, for example, JP-B 60-27562, JP-A 61-94724, JP-A 61-947245, JP-A 61-104813, JP-A 61-158413, and JP-A 6-134933.

### <Drying Step>

The dopes subjected to the casting are dried on the drum or band. The web is peeled off at a peeling position just before the web travels entire circumference of the drum or belt and transported by a method in which the web is passed alternately between rolls arranged in a zigzag form, a method in which both edges of the peeled web are clamped with a clip or the like to transport the web in a contactless manner, or the like. The drying is achieved by a method in which air of a certain temperature is applied to the both surfaces of the web (film) being transported, or a method using a heating means or the like, such as microwave. A rapid dry possibly deteriorates the planarity of the resultant film, and therefore, it is preferred that in the initial phase of the drying, the web is dried at such a temperature that the solvent does not foam, and after the drying proceeds to some extent, the drying is performed at a higher temperature. In the drying step after peeling the film from the support, the film tends to shrink in a longitudinal direction or in a width direction due to the vaporization of the solvent. A higher temperature at the drying results in a larger shrinkage. It is preferred that the drying is performed while the shrinkage is suppressed as much as possible, in terms of good planarity of the finished film. In this viewpoint, the method in which an entire or a part of drying step is carried out while both the width edges of the web are fixed in a width direction with clips or pins to maintain the width of the web (tenter method) as described in JP-A 62-46625 is preferred. The drying temperature in the drying step is preferably 100 to 145° C. The drying temperature, the amount of drying air, and the time period for drying are different depending on the solvent used, and the factors may be selected according to the kind and combination of the solvents used.

It is preferred that the dopes subjected to a casting to form a multilayer are peeled from the support after dried on the support.

### <Post-Treatment Step>

After the film formation on the support, the laminated film is peeled from the support. The peeled laminated film may further be subjected to a stretching treatment, a constriction treatment, a heat treatment, a heated steam treatment (a treatment in which steam is sprayed on the film), a surface treatment, or the like. The stretching treatment and the constriction treatment may be a treatment for adjusting the optical properties of the layer A within a desired range. In addition, the surface treatment (acid treatment, alkali treatment, plasma treatment, corona treatment, etc.) may be a treatment for the purpose of improving the adhesiveness of the layer A relative to the other layers.

### Production Method of Optical Film

The present invention also relates to a method for producing an optical film by utilizing the laminated film of the invention. The production method of the optical film of the invention is characterized by comprising: providing the laminated film of the invention; and bonding the retardation layer A with another film (for example, a polarizing film or another retardation film) when, after, or before the layer B is peeled from the laminated film. Through this procedure, the retardation layer A can be transferred from the surface of the layer B to the surface of another layer.

The peeling of the layer B can be initiated from a point of physical bending, turning up from a cut edge, or heat or heat-moisture treatment. The peeling can be achieved by utilizing difference between the layers, such as difference in physical and mechanical properties (ductility or toughness), difference in physical change such as size change due to the heat or moisture-heat treatment, or difference in shear rate in the vertical, film thickness direction. These can be selected depending on the characteristics of the film. Also in the aspect where the layers are peeled by utilizing difference in the size change due to heat or moisture-heat, at the time of the peeling, a heat roll or a heated steam is applied to a desired portion to cause a local change in dimension or the like, the difference in the amount of the change between the layers is allowed to act as a shear force, and thus the peeling is initiated when the force exceeds the adhesiveness between the layers.

The layer B peeled may be discarded as it is, or may be used for another use. One example thereof is an aspect in which the peeled layer B is, for example, cut or pulverized to recover the polymer material which is the main component of the layer B, and the material is reused for preparation of the dope for forming the layer B in the laminated film of the invention. The material is then subjected to solvent co-casting with the dope for forming the layer A to produce the laminated film of the invention. The recovery and reuse of the polymer material for the layer B makes it possible to achieve production cost saving and waste reduction.

### Polarizing Plate

The present invention also relates to a polarizing plate at least comprising the retardation layer A transferred from the laminated film of the invention and a polarizing film. In a polarizing plate having a polarizing film and a protective film disposed on at least one side of the polarizing film, the retardation layer A can be used as the protective film. In addition, another film (a protective film, a retardation film, etc.) may be disposed between the retardation layer A and the polarizing film.

In a configuration of the polarizing plate in which a protective film is disposed on each of two surfaces of the polarizing film, the retardation layer A may be used as one of the protective films.

As polarizing film, exemplified are an iodine-based polarizing film, a dye-based polarizing film containing dichroic dye, and a polyene-based polarizing film. The iodine-based polarizing film and a dye-based polarizing film generally can be produced using a polyvinyl alcohol-based film.

The thickness of the polarizing film is not particularly limited, but as the thickness of the polarizing film is smaller, the polarizing plate and the liquid crystal display device in which the polarizing plate is incorporated can be more reduced in thickness. From this viewpoint, the thickness of the polarizing film is preferably 10 μm or less. The lower limit of the thickness of the polarizing film is 0.7 μm or more, and substantially 1 μm or more since the optical path within the polarizing film is required to be larger than the wavelength of light, and in general, the thickness is preferably 3 μm or more.

### Liquid Crystal Display Device

The present invention also relates to a liquid crystal display device at least comprising the retardation layer A transferred from the laminated film of the invention, or the above-mentioned polarizing plate of the present invention. The orientation mode of the liquid crystal display device is not particularly limited, and the liquid crystal display device may be one utilizing any of a horizontal orientation mode (an IPS mode or an FFS mode), a TN mode, a VA mode, an OCB mode, an ECB mode, and the like.

One aspect of the liquid crystal display device is a liquid crystal display device of a horizontal orientation mode. In this aspect, when the layer A satisfies nz≧nx≧ny, that is, the layer A is, as it is called, a positive C-plate or a positive B-plate, the layer A contributes to a viewing angle compensation of the liquid crystal display device of a horizontal orientation mode. In this aspect, more specifically, preferred is an aspect in which the layer A has Re of 0 to 10 nm and Rth of −50 to −300 nm, or in which the layer A has Re of 50 to 150 nm and Rth of −150 to −50 nm. Furthermore, preferred is an aspect in which the layer A has Re of 0 to 5 nm and Rth of −60 to −200 nm, or in which the layer A has Re of 60 to 140 nm and Rth of −140 to −60 nm.

The retardation layer A may be incorporated in the liquid crystal display device in a form of polarizing plate in which the layer A is bonded with a polarizing film. Alternatively, the retardation layer A may be, singly or in a laminate with another retardation layer, incorporated as a viewing angle compensation film. The other retardation layer to be combined therewith may be selected depending on the orientation mode or the like of the liquid crystal cell to be compensated for the viewing angle. In the aspect of the liquid crystal display device of horizontal orientation mode as mentioned above, the other retardation layer to be combined with the retardation layer A is, in an aspect where the retardation layer A is a positive C-plate, preferably a negative B-plate (for example, a retardation plate having Re of approximately 100 nm and Rth of approximately 100 nm), and in an aspect where the retardation layer A is a positive B-plate, preferably a negative C-plate (for example, a retardation plate having Re of approximately 0 nm and Rth of approximately 100 nm).

The retardation layer A may be disposed between a liquid crystal cell and a polarizing film on the visible side, or may be disposed between a liquid crystal cell and a polarizing film on the backlight side. For example, in the aspect of the horizontal orientation mode as mentioned above, the retardation layer A is preferably disposed between a liquid crystal cell and a polarizing film on the visible side in an IPS mode, and preferably disposed between a liquid crystal cell and a polarizing film on the backlight side in an FFS mode.

As used herein, Re (λ) and Rth (λ) represent an in-plane retardation and a retardation in the thickness direction, respectively, at a wavelength λ. Re (λ) may be measured by KOBRA 21ADH or WR (manufactured by Oji Scientific Instruments) with light having a wavelength of λ nm incident in the normal direction of a film. Upon selecting the measurement wavelength λ nm, the measurements may be performed by changing filters for wavelength selection manually or by converting the measured value using a program or the like.

In the case where the film to be measured is expressed by a uniaxial or biaxial index ellipsoid, Rth (λ) may be calculated in the following procedure.

Light having a wavelength of λ nm is allowed to enter the film from six directions in total tilting about the in-plane slow axis (determined by KOBRA 21ADH or WR) as the axis of tilt (the axis of rotation) in the range of 0 to 50 degrees toward one side relative to the normal direction of the film at intervals of 10 degrees. When there is no slow axis, however, an arbitrary in-plane direction of the film is taken as the axis of rotation. Thus, Re (λ) as described above is measured at each of the six directions and Rth (λ) is computed by KOBRA 21ADH or WR based on the thus-obtained retardation values, an assumed value of the average refractive index, and an input film thickness value.

In the above description, in the case of a film in which, when the incident light is thus inclined about the in-plane slow axis as the axis of rotation starting from the normal direction, and there is a direction of a certain tilt angle where the retardation value is zero, the retardation values at tilt angles larger than the certain tilt angle are then changed in their signs to negative and thereafter Rth (λ) is computed by KOBRA 21ADH or WR.

Alternatively, Rth also can be calculated as follows. Retardation values in an arbitrary inclined two directions about the slow axis as the axis of tilt (the axis of rotation) are measured (in the case of absence of the slow axis, however, an arbitrary in-plane direction of the film is taken as the axis of rotation,) and Rth is determined by the equations (1) and (2) based on the obtained values, an assumed value of the average refractive index and an input film thickness value.

$$\begin{matrix}[ Math . 1 ] & \\ Re ( θ ) = \begin{matrix}[ nx - \frac{( ny \times nz )}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \\ \frac{d}{cos \{ {sin}^{- 1} ( \frac{sin ( - θ )}{nx} ) \}}\end{matrix} & Equation ( 1 ) \\ Rth = \{ ( nx + ny ) / 2 - nz \} \times d & Equation ( 2 )\end{matrix}$$

In these equations, Re(θ) represents a retardation value in a direction that is θ degrees inclined from the normal direction, nx represents a refractive index in the direction of the in-plane slow axis, ny represents a refractive index in the in-plane direction perpendicular to nx, and nz represents a refractive index in the direction perpendicular to nx and ny, and d represents the film thickness.

When the film to be measured can not be expressed as a uniaxial or biaxial index ellipsoid, that is, the film is, as it is called, a film having no optic axis, Rth(λ) is calculated as follows.

Light having a wavelength of λ nm is allowed to enter the film from eleven directions in total tilting about the in-plane slow axis (determined by KOBRA 21ADH or WR) as the axis of tilt (the axis of rotation) in the range of −50 to +50 degrees relative to the normal direction of the film at intervals of 10 degrees. Thus, Re(λ) is measured at each of the eleven directions and Rth(λ) is computed by KOBRA 21ADH or WR based on the thus-obtained retardation values, an assumed value of the average refractive index, and an input film thickness value.

In the above measurement, as the assumed value of the average refractive index, the value found in the Polymer Handbook (John Wiley & Sons, Inc.) or in catalogs of various optical films may be used. For the material whose average refractive index value is not known, the value can be measured by the Abbe's refractometer. The average refractive index values of major optical films are exemplified below: cellulose acylate (1.48), cycloolefin polymer (1.52), polycarbonate (1.59), polymethylmethacrylate (1.49), and polystyrene (1.59). By inputting the assumed values of the average refractive index and the film thickness, KOBRA 21ADH or WR computes nx, ny, and nz. Nz=(nx−nz)/(nx−ny) is further computed from the thus-obtained nx, ny, and nz.

The measurement wavelength of the refractive indices is herein 550 nm unless otherwise specified.

### EXAMPLES

The characteristics of the present invention will be hereinunder described more specifically with reference to the examples.

Materials, amounts, proportions, and details and procedures of treatment, etc. shown in the following examples can be appropriately changed unless departing from the spirit of the invention. Therefore, the scope of the present invention is not to be construed as limited to the specific examples shown below.

Unless otherwise specified, “part” or “parts” is based on the mass.

### Measurement Method

### <Three-Dimensional Refractive Indices>

Three-dimensional refractive indices were measured by an ellipsometry (model M2000V, J.A. Woollam Co.) in which the wavelength λ was set to 550 nm.

### <Tensile Modulus E′>

For each film sample, a stress at 0.5% elongation in a tensile speed of 10%/min was measured using a universal tensile tester STM T 50BP (manufactured by Toyo Boldwin) in an atmosphere of 23° C. and 70% RH, whereby the tensile modulus was determined.

### <Interlayer Peeling Force>

The interlayer peeling force was measured for each film sample by a 90 degree peeling test method. Specific procedure is as follows.

1. Each film sample is bonded onto the glass plate via an adhesive. For example, the film sample is bonded to the glass plate with the layer A arranged on the side of the glass plate (on the lower side) and the layer B arranged on the upper side. The size of each film sample is 1 cm in width×15 cm in length, and the length of the bonded portion is 7 cm.

2. The peeling at the interface between the layer A and the layer B is advanced by pulling the layer B in a direction of 90 degree, and only the end of the film is peeled off. The load at this time is measured and taken as the interlayer peeling force.

### 1. Production and Evaluation of Laminated Film

### (1) Preparation of Dope

### <Preparation of Dope>

Dopes having compositions shown in the table below were prepared. All the dopes were prepared so as to have a total solid concentration of 20% by mass.

### (2) Film Formation by Solvent Co-Casting

Each dope A and each dope B were combined as shown in the table below, and a laminate of the layer A and the layer B was produced. Specifically, each dope B and each dope A were subjected to co-casting by passing the dopes through a casting gieser capable of co-casting onto a metal support with the dope B arranged on the side of the support. The dopes were dried with a dry air to be made into a film on the support, and each laminated film obtained was peeled from the support.

In the table below, the film No. 09 was formed by subjecting only the dope A to the solvent casting method. In addition, the film No. 13 was produced by similarly subjecting the dope B, dope A, and dope B to co-casting by passing the dopes through a casting gieser capable of three-layer co-casting onto a metal support, whereby a laminated film having three-layer structure of the layer B/layer A/layer B was produced.

### 2. Evaluation of Laminated Film

The properties of each film obtained were measured by the method described above. For the measurement of the interlayer peeling force, there were some samples that could not be measured because the film was, for example, raptured during the measurement. The rupture or the like during the measurement was also described in the table below.

The transportability of each film in transportation following the endless running of the support during the film formation was evaluated by observing presence or absence of the separation of the layer A and the layer B or the like. The results are shown in the table below.

In addition, the number of the bright spot was determined for each film obtained by the following method. The bright spots present in the film are caused due to scratches and the like in the film generated during peeling the film from the support or during transporting the film on the support in the film formation. Accordingly, it can be said that the smaller the number of the bright spot is, the better the production suitability and the better the handling property. The results are shown in the table below.

In the table, “N/100 viewing fields” means that the number of the bright spots observed was N, when, in the observed measurement using a polarization microscope, the film was placed between a polarizer and an analyzer that were arranged in a cross Nicol state such that the polarizer and the film slow axis coincide with each other and then the number of bright spots in a dark field state was counted.

TABLE 1

| | Layer A | | | | | | | |
|---|---|---|---|---|---|---|---|---|
| | | | Tensile | | | | | |
| | | | modulus | | | | | Layer B |
| | Material | Thickness | E′ | Solvent | | | | Material |
| Film No. | *1 | (μm) | (GPa) | *2 | nx | ny | nz | *1 |
| 01 | P1 | 20 | 2.5 | 100/0 | 1.520 | 1.520 | 1.521 | CTA |
| (Comparative | | | | | | | | (2.86) |
| Example) | | | | | | | | |
| 02 | P2 | 20 | 2.0 | 100/0 | 1.520 | 1.519 | 1.521 | CTA |
| (Example) | | | | | | | | (2.86) |
| 03 | P3 | 20 | 2.0 | 100/0 | 1.488 | 1.487 | 1.492 | CTA |
| (Example) | | | | | | | | (2.86) |
| 04 | P4 | 20 | 2.2 | 100/0 | 1.487 | 1.487 | 1.492 | CTA |
| (Example) | | | | | | | | (2.86) |
| 05 | P5 | 20 | 3.1 | 100/0 | 1.602 | 1.601 | 1.597 | CTA |
| (Example) | | | | | | | | (2.86) |
| 06 | P6 | 20 | 2.5 | 100/0 | 1.520 | 1.520 | 1.520 | CTA |
| (Example) | | | | | | | | (2.86) |
| 07 | P6 | 20 | 2.5 | 100/0 | 1.520 | 1.520 | 1.520 | P2 |
| (Comparative | | | | | | | | |
| Example) | | | | | | | | |
| 08 | P1 | 3 | 2.5 | 100/0 | 1.520 | 1.520 | 1.521 | CTA |
| (Comparative | | | | | | | | (2.86) |
| Example) | | | | | | | | |
| 09 | P3 | 20 | 2.0 | 100/0 | 1.488 | 1.487 | 1.492 | — |
| (Comparative | | | | | | | | |
| Example) | | | | | | | | |
| 10 | CTA | 20 | 2.8 | 87/13 | 1.483 | 1.482 | 1.476 | CTA |
| (Comparative | (2.43) | | | | | | | (2.86) |
| Example) | | | | | | | | |
| 11 | P6 | 20 | 2.5 | 100/0 | 1.520 | 1.520 | 1.520 | CTA |
| (Example) | | | | | | | | (2.86) |
| 12 | P6 | 20 | 2.5 | 100/0 | 1.520 | 1.520 | 1.520 | CTA |
| (Example) | | | | | | | | (2.86) |
| 13*3 | P4 | 20 | 2.2 | 100/0 | 1.487 | 1.487 | 1.492 | CTA |
| (Example) | | | | | | | | (2.86) |

| | Layer B | | | | Evaluation | | |
|---|---|---|---|---|---|---|---|
| | | | Tensile | | Interlayer | | |
| | | | modulus | | adhesiveness of | Interlayer | Evaluation of |
| | Solvent | Thickness | E′ | Thickness × | film upon web | peeling force | bright spots in |
| Film No. | *2 | (μm) | (GPa) | E′ | transportation | N/cm | laminated film |
| 01 | 87/13 | 20 | 3.0 | 60 | Interlayer peeling | 0.03 | 15/100 |
| (Comparative | | | | | occurred during | | viewing fields |
| Example) | | | | | transportation | | |
| 02 | 87/13 | 20 | 3.0 | 60 | Transportable | 0.6 | 15/100 |
| (Example) | | | | | | | viewing fields |
| 03 | 87/13 | 20 | 3.0 | 60 | Transportable | 0.4 | 15/100 |
| (Example) | | | | | | | viewing fields |
| 04 | 87/13 | 20 | 3.0 | 60 | Transportable | 0.4 | 15/100 |
| (Example) | | | | | | | viewing fields |
| 05 | 87/13 | 20 | 3.0 | 60 | Transportable | 0.6 | 15/100 |
| (Example) | | | | | | | viewing fields |
| 06 | 87/13 | 20 | 3.0 | 60 | Transportable | 0.5 | 15/100 |
| (Example) | | | | | | | viewing fields |
| 07 | 100/0 | 20 | 3.0 | 40 | Transportable | Not measurable Film | — |
| (Comparative | | | | | | cracked during peeling | |
| Example) | | | | | | of layer B | |
| 08 | 87/13 | 20 | 3.0 | 60 | Transportable | Not measurable Film | — |
| (Comparative | | | | | | raptured | |
| Example) | | | | | | | |
| 09 | | — | — | — | Film was not | — | — |
| (Comparative | | | | | transportable | | |
| Example) | | | | | | | |
| 10 | 87/13 | 20 | 3.0 | 60 | Transportable | 35 | 15/100 |
| (Comparative | | | | | | | viewing fields |
| Example) | | | | | | | |
| 11 | 87/13 | 8 | 3.0 | 24 | Transportable | 0.4(Ruptured rarely | 15/100 |
| (Example) | | | | | | occurred during | viewing fields |
| | | | | | | measurement) | |
| 12 | 87/13 | 110 | 3.0 | 330 | Transportable | 0.4 | 50/100 |
| (Example) | | | | | | | viewing fields |
| 13*3 | 87/13 | 20 | 3.0 | 60 | Transportable | 0.4 Front side*3 | 5/100 |
| (Example) | | | | | | 0.5 Back side*3 | viewing fields |

*1: P1: polystyrene ″G9504″ from PS Japan; P2: styrene/maleic anhydride copolymer ″D332″ from NOVA Chemicals; P3: a resin obtained through the same procedure as in the synthesis example in Example 1 of JP-A 2006-328132; P4: a resin obtained through the same procedure as in the synthesis example in Example 2 of JP-A 2006-328132; P5: ″Panlite L1225″ from TEIJIN, used as a dope by dissolving it in a methylene chloride solution at 25% by mass; P6: ″Dianal BR88″ from Mitsubishi Rayon;
CTA: cellulose acetate, the numerical values in parentheses mean acetyl substitution degree.
*2: The solvent composition is represented in terms of mass ratio of methylene chloride/methanol.
*3: Film No.13 is a laminated film with three-layer structure of layer B/layer A/layer B, ″Front side″ means interlayer peeling force between layer B and layer A on front surface side during film formation, and ″Back side″ means interlayer peeling force between layer B and layer A on support side during film formation.

From the results shown in the table above, the laminated films of the Examples produced by solvent co-casting were good in transportability during the film formation, good in peeling property from the support, and excellent in handling property, since the film contained the layer B which had a higher tensile modulus than the layer A.

When separation between the layer A and the layer B was tried in the laminated films of Examples, the layer A could be easily peeled from the layer B without any rupture or damage of the layers in all the examples, and it was confirmed that the layer A could be peeled from the layer B to be used singly.

On the other hand, in the film No. 09 of the comparative example, the dope A was subjected to the solvent casting alone in a 20 μm thin layer, and therefore the film was inferior in handling property both during the film formation and during the peeling off.

In addition, the film No. 1 of the comparative example was a laminated film obtained by subjecting the dope A to co-casting along with the dope B, the interlayer peeling force between the layer A and the layer B was less than the range defined in the present invention (specifically, 0.03 N/cm), and therefore the adhesiveness between the layer A and the layer B was not sufficient and the peeling occurred during transportation and the effect in improvement of handling property could not be attained.

The film No. 07 of the comparative example was a laminated film obtained by subjecting the dope A to co-casting along with the dope B, but the tensile modulus of the layer B was less than that of the layer A, and therefore the effect in improvement of handling property could not be attained.

The film No. 08 of the comparative example was also a laminated film obtained by subjecting the dope A to co-casting along with the dope B, but the thickness of the layer A was less than 5 μm (specifically 3 μm), and therefore, the deterioration in handling property could not be suppressed even by the formation of the layer B.

The film No. 10 of the comparative example was also a laminated film obtained by subjecting the dope A to co-casting along with the dope B, and the handling property was good both during the transportation and during the peeling. However, when separation between the layer A and the layer B was tried, the adhesiveness was too high and therefore, it was not possible that the layer A was peeled from the layer B to be used singly.

### 2. Reuse of Material for Layer B

Only the layer B was peeled from the laminated film of the film No. 03, and cut into fine pieces and pulverized, and thereafter dissolved again in methylene chloride, whereby a dope B was prepared. A laminated film No. 03a was produced by subjecting the dope B to co-casting along with the dope A in the same procedure as for the film No. 3 except for using the thus obtained dope B.

In addition, a laminated film No. 03b was produced by subjecting the dope B to co-casting along with the dope A in the same procedure as for the film No. 3 except for using this dope B and changing the dope A, and performing 25%-longitudinal uniaxial stretching at 120° C. with a stretching machine.

Also for the films No. 03a and 03b obtained, the properties were measured in the same procedures as described above, and the evaluation was performed for each item in the same method as described above. The results are shown in the table below. The results of the film No. 03 are shown together.

From the results shown in the table below, it can be understood that good evaluation results were achieved for the laminated films obtained by reusing the layer B peeled, similar to the examples described above. Furthermore, the reason why the evaluation result of the bright spots was improved in the case of implementing the reuse is presumed as follows. That is, it is because the film had once been subjected to the solvent casting and thus once passed through a filtering facility, and therefore foreign matters in the film had been reduced, and in the case, such a film was used again.

TABLE 2

| | | | | | | | | | | | | Evaluation | | |
|---|---|---|---|---|---|---|---|---|---|---|---|---|---|---|
| | | | | | | | | | | | | Interlayer | | |
| | | | | | | | | | | | | adhesive- | | Eval- |
| | Layer A | | | | | | Layer B | | | | | ness | Inter- | uation |
| | | | Tensile | | | | | | Tensile | | Reuse | of film | layer | of bright |
| | | Thick- | modulus | | | | | Thick- | modulus | | Im- | upon web | peeling | spots in |
| | Material | ness | E′ | | | | Material | ness | E′ | Thickness × | plemented | trans- | force | laminated |
| Film No. | *1 | (μm) | (GPa) | nx | ny | nz | *1 | (μm) | (GPa) | E′ | or not | portation | N/cm | film |
| 03 | P3 | 20 | 2.0 | 1.488 | 1.487 | 1.492 | CTA | 20 | 3.0 | 60 | Not | Transport- | 0.4 | 15/100 |
| (Example) | | | | | | | (2.86) | | | | Im- | able | | viewing |
| | | | | | | | | | | | plemented | | | fields |
| 03a | P3 | 20 | 2.0 | 1.488 | 1.487 | 1.492 | CTA | 20 | 3.0 | 60 | Im- | Transport- | 0.5 | 5/100 |
| (Example) | | | | | | | (2.86) | | | | plemented | able | | viewing |
| | | | | | | | | | | | | | | fields |
| 03b | P3 | 20 | 2.0 | 1.481 | 1.476 | 1.483 | CTA | 20 | 3.0 | 60 | Im- | Transport- | 0.5 | 5/100 |
| (Example) | | | | | | | (2.86) | | | | plemented | able | | viewing |
| | | | | | | | | | | | | | | fields |

*1: P3 means a resin obtained through the same procedure as in the synthesis example in Example 1 of JP-A 2006-328132; CTA means cellulose acetate, and numerical values in parentheses mean acetyl substitution degree.

### 3. Evaluation in Mounting

### (1) Formation of Adhesive Layer

An adhesive layer was formed on the surface of the layer A of each of the films No. 03a and 03b produced above using the following adhesive composition.

Into a four-neck flask equipped with a condenser, a stirring blade and a thermometer, put were 91 parts by mass of butyl acrylate, 3 parts by mass of acrylic acid, 1.5 parts by mass of N-(2-hydroxyethyl) acrylamide, 4.5 parts by mass of DMAA (N,N-dimethylacrylamide), and 0.2 part by mass of benzoyl peroxide, along with 200 parts by mass of toluene, thoroughly purged with nitrogen, and then the mixture was reacted at about 60° C. for 8 hr with stirring under nitrogen flow, whereby a solution of acrylic copolymer having a weight average molecular weight of 1,800,000 (in terms of GPC polystyrene) was obtained. Relative to 100 parts by mass of solid content in this solution of acrylic copolymer, an isocyanate-based crosslinking agent (Coronate L, from Nippon Polyurethane Industry, Co., Ltd.) was added in an amount of 0.5 parts by mass in terms of solid content, whereby the adhesive solution was prepared.

The resulting adhesive solution was applied onto a separator made of a polyester film subjected to a releasing treatment (thickness: 35 μm) by a reverse roll coating method so as to give a thickness of the adhesive layer after drying of 20 μm, and subjected to a heat treatment at 155° C. for 3 min to vaporize the solvent, whereby the adhesive layer was obtained. This adhesive layer was laminated on the surface of the layer A of each of the films No. 03a and 03b produced above, whereby each laminated film with adhesive was produced.

### (2) Lamination of Another Retardation Film

Retardation films RFa and RFb which had optical properties shown in the table below were provided. The retardation films RFa and RFb each were produced by solvent casting using a dope that contains a cellulose acetate resin as a main component thereof, and, as required, contains a plasticizer, such as an ester-based oligomer plasticizer, added thereto. Subsequently, the retardation films were subjected to a stretching treatment, as required, for regulating the optical properties. The solvent casting and the stretching treatment were conducted referring to the method, conditions, and the like described in JP-A 2011-118339.

The layer B was peeled from each of the laminated films No. 03a and 03b with adhesive, and one of the retardation films RFa and RFb in a combination shown in the table below was bonded to the surface of the adhesive layer such that the slow axes were in parallel. The layer B could be easily peeled off and any rupture or damage did not occur in the peeling. In such a manner, viewing angle compensation films Fa and Fb in which the retardation layer A and the respective other retardation films RFa and RFb were laminated were produced.

Re and Rth of the retardation layer A included in each of the films No. 03a and 03b are also shown in the table below.

TABLE 3

| | Retardation | | | | | |
|---|---|---|---|---|---|---|
| Viewing angle | layer A | | | Another retardation film | | |
| compensation film | Film | Re | Rth | Film | Re | Rth |
| No. | No. | (nm) | (nm) | No. | (nm) | (nm) |
| Fa | 03a | 20 | −90 | RFa | 100 | 98.0 |
| Fb | 03b | 100 | −90 | RFb | 1 | 115.0 |

### (3) Production of Polarizing Plate

A polyvinyl alcohol-based polarizing film dyed with iodine (thickness: 8 μm) was provided as the polarizing film.

The viewing angle compensation film Fa produced above was bonded to one surface of this polarizing film using a 3% aqueous solution of PVA (PVA-117H, from Kuraray) as an adhesive such that the in-plane slow axis of the viewing angle compensation film Fa and the absorbance axis of the polarizing film were in parallel. At this time, the structure was made in which one surface of the other retardation film RFa was bonded with one surface of the PVA polarizing film, and the retardation layer A was laminated on the other surface of the film RFa. In addition, a commercially available cellulose triacetate film was bonded to the other surface of the polarizing film using the above adhesive. In such a manner, a polarizing plate a was produced.

The viewing angle compensation film Fb produced above was bonded to one surface of another polarizing film using a 3% aqueous solution of PVA (PVA-117H, from Kuraray) as an adhesive such that the slow axis of the viewing angle compensation film Fb and the absorbance axis of the polarizing film were in parallel. At this time, the structure was made in which one surface of the retardation layer A was bonded with one surface of the PVA polarizing film, and the other retardation film Rfb was laminated on the other surface of the retardation layer A. In addition, a commercially available cellulose triacetate film was bonded to the other surface of the polarizing film using the above adhesive. In such a manner, a polarizing plate b was produced.

A polarizing plate c in which Z-TAC (cellulose acetate film with low retardation, from Fujifilm) was bonded to one surface of a polarizing film and a commercially available cellulose triacetate film was bonded to the other surface of the polarizing film was provided as a polarizing plate used in combination with each of the above polarizing plates a and b.

### (4) Provision of Liquid Crystal Cell

A liquid crystal panel was taken from a 32-inch liquid crystal display device [liquid crystal television, trade name [Wooo] (model: W32-L7000), manufactured by Hitachi] including an IPS mode liquid crystal cell, all the optical films disposed on the upper and lower sides of the liquid crystal cell were removed, and the glass surfaces on the front and rear sides of the liquid crystal cell were washed.

### (5) Production of Liquid Crystal Display Device

The polarizing plate a was bonded to the display side surface of the liquid crystal cell of IPS mode and the polarizing plate c was bonded to the backlight side surface thereof such that the absorbance axes were oriented perpendicular to each other. Both the polarizing plates were bonded such that the commercially available cellulose acetate films faced the outside. In this manner, a liquid crystal display device LCDa of IPS mode was fabricated.

The polarizing plate b was bonded to the display side surface of the liquid crystal cell of IPS mode and the polarizing plate c was bonded to the backlight side surface thereof such that the absorbance axes were oriented perpendicular to each other. Both the polarizing plates were bonded such that the commercially available cellulose acetate films faced the outside. In this manner, a liquid crystal display device LCDb of IPS mode was fabricated.

### (6) Evaluation of Liquid Crystal Display Device

When the resulting LCDa and LCDb were allowed to display in black mode and observed from an oblique direction, the display devices realized an ideal black display without leak of light.

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2012/083425, filed Dec. 25, 2012; and Japanese Patent Application No. 2011-283783 filed on Dec. 26, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims.

What is claimed is:

1. A laminated film comprising a retardation layer A and a layer B that are formed through solvent co-casting, wherein
the layer A has a thickness of 5 μm or more and 30 μm or less;
the layer B has a higher tensile modulus compared to the layer A; and
an interlayer peeling force between the layer A and the layer B is 0.05 N/cm or more and 5 N/cm or less.

2. The laminated film according to claim 1, wherein the layer B has a thickness d and an tensile modulus E′ that satisfy the following expression:
30≦E′×d≦300
wherein the unit of d is μm and the unit of E′ is GPa.

3. The laminated film according to claim 1, wherein the layer A has refractive indices nx, ny, and nz that satisfy the following expression:
nz≧nx≧ny
wherein nx represents an in-plane refractive index in an in-plane slow axis direction, ny represents an in-plane refractive index in a direction perpendicular to the in-plane slow axis direction, and nz represents a refractive index in a thickness direction.

4. The laminated film according to claim 1, wherein the layer B contains a cellulose ester as a main component.

5. The laminated film according to claim 1, wherein the layer B contains a cellulose acetate that has a degree of acetyl substitution of 2.6 to 2.95 as a main component.

6. The laminated film according to claim 1, wherein the layer A has a thickness of 13 μm or more and 25 μm or less.

7. The laminated film according to claim 1, which has an tensile modulus difference ΔE′ between the layer A and the layer B of 0.4 GPa or more.

8. The laminated film according to claim 1, wherein the layer B has a thickness of 10 μm or more and 40 μm or less.

9. The laminated film according to claim 1, wherein the layer A contains at least one of an acrylic resin, a styrene-based resin, and a polyester-based resin, as a main component.

10. The laminated film according to claim 1, comprising an adhesive layer on the surface of the layer A that is not in contact with the layer B.

11. A polarizing plate comprising a retardation layer A transferred from a laminated film and a polarizing film wherein the laminated film comprises the retardation layer A and a layer B that are formed through solvent co-casting, the layer A has a thickness of 5 μm or more and 30 μm or less, the layer B has a higher tensile modulus compared to the layer A, and an interlayer peeling force between the layer A and the layer B is 0.05 N/cm or more and 5 N/cm or less.

12. The polarizing plate according to claim 11, wherein the polarizing film has a thickness of 10 μm or less.

13. A liquid crystal display device comprising a retardation layer A transferred from a laminated film, wherein the laminated film comprises the retardation layer A and a layer B that are formed through solvent co-casting, the layer A has a thickness of 5 μm or more and 30 μm or less, the layer B has a higher tensile modulus compared to the layer A, and an interlayer peeling force between the layer A and the layer B is 0.05 N/cm or more and 5 N/cm or less.

14. A method for producing an optical film from a laminated film, wherein
the laminated film comprises a retardation layer A and a layer B that are formed through solvent co-casting, the layer A has a thickness of 5 μm or more and 30 μm or less, the layer B has a higher tensile modulus compared to the layer A, and an interlayer peeling force between the layer A and the layer B is 0.05 N/cm or more and 5 N/cm or less.
the method comprises bonding the retardation layer A with another film, when, after, or before the layer B is peeled from the laminated film.

15. The method according to claim 14, wherein the other film is a polarizing film or a retardation film.

16. The method according to claim 14, further comprising reusing the layer B peeled as a material for forming the layer B in solvent co-casting to produce the laminated film.
